(19) United States
(12) Patent Application Publication
(10) Pub. No.: US 2012/0038313 A1
(43) Pub. Date: Feb. 16, 2012

(54) Fuel Cell Based Hybrid Electric Renewable Micro Power Pack

(76) Inventor: Anil ANANTHAKRISHNA, Norcross, GA (US)

(21) Appl. No.: 13/117,659

(22) Filed: May 27, 2011

Related U.S. Application Data
(63) Continuation-in-part of application No. 12/729,211, filed on Mar. 22, 2010.
Application No. 12/729,211 is a continuation of application No. 12/887,454, filed on Sep. 21, 2010, now abandoned.
(60) Provisional application No. 61/162,238, filed on Mar. 20, 2009.
(60) Provisional application No. 61/237,213, filed on Aug. 26, 2009.

(51) Int. Cl. H02J 7/00

(52) U.S. Cl. 320/101

(57) ABSTRACT

A fuel cell based hybrid power pack is disclosed. In one aspect, a device includes an energy storage unit operatively coupled to a load of a battery operated device for delivering electric energy to the load, where the battery operated device operates based on the electric energy supplied to the load. The device also includes fuel cell unit coupled to the energy storage unit for replenishing electric energy consumed by the load from the energy storage unit. The energy storage unit is charged when not being charged using an external power source.

### PRIORTIY CLAIM

Benefit is claimed as a continuation application to, U.S. Non-Provisional application Ser. No. 12/887,454, entitled “FUEL CELL BASED HYBRID ELECTRIC RENEWABLE MICRO POWER PACK” Anil Ananthakrishna, filed on 22 Mar. 2010 and as a continuation-in-part application to U.S. Non-Provisional application Ser. No. 12/729,211, entitled “ENERGY STORAGE AND GENERATION SYSTEM FOR AN ELECTRICALLY” by Anil Ananthakrishna, filed on 22 Mar. 2010 which claims benefit under 35 U.S.C. 119(e) of U.S. Provisional Application Ser. No. 61/162,238, entitled “FLYWHEEL POWER SYSTEM IN AN ELECTRIC VEHICLE” by Anil Ananthakrishna, filed on Mar. 20, 2009 and further claims benefit under 35 U.S.C. 119(e) to U.S. Provisional Application Ser. No. 61/237,213, entitled “FUEL CELL BASED HYBRID ELECTRIC RENEWABLE MICRO POWER PACK” by Anil Ananthakrishna, filed on 26 Aug. 2009 all of which are herein incorporated in entirety by reference for all purposes.

### BACKGROUND OF THE INVENTION

1. Field of the Invention

Embodiments of the disclosure generally relate to the field of power pack, and more particularly to fuel cell based power pack.

2. Summary of the Prior Art

Today, battery operated devices are used for a wide variety of personal, commercial and automobile applications. These devices include digital cameras, computers, communication devices, motor vehicles etc. The battery used in most of these devices is rechargeable, that includes lithium ion, lithium polymer, nickel-cadmium, nickel-hydrogen, nickel-metal hydride, and lead acid batteries. Some of these devices have built-in charging systems while others require external charging system for the charging the batteries.

These batteries are typically recharged by connecting to an external power source such as a wall receptacle in a home or office or a power outlet in a motor vehicle. There are situations, when an external power source is not immediately available to recharge the batteries. In such cases, the user may have to carry disposable primary batteries, arrange access to a portable gasoline-powered generator, or arrange access to a charging system that operates on a large storage battery system. In most situations, these alternatives may be undesirable or unavailable.

There have been many sources of electrical power generation such as nuclear energy, coal, fossil fuel power generation plants that are not always feasible, causes excessive pollution, exhaustion of resources and non-economical. In the recent past, fuel cells are generally used as a primary supply of power in battery operated devices. Although, the fuel cell provides a clean usage solution, the efficiency of the fuel cell depends on corresponding load variation. Since different devices require different level of power to be supplied, fuel cells alone for primary usage may give rise to economical and power density challenges.

### SUMMARY OF THE INVENTION

This Summary is provided to comply with 37 C.F.R. §1.73, requiring a summary of the invention briefly indicating the nature and substance of the invention. It is submitted with the understanding that it will not be used to interpret or limit the scope or meaning of the claims.

A fuel cell based hybrid electric renewable micro power pack is disclosed. In one aspect, a device includes an energy storage unit operatively coupled to a load of a battery operated device for delivering electric energy to the load, where the battery operated device operates based on the electric energy supplied to the load. The device also includes fuel cell unit coupled to the energy storage unit for replenishing electric energy consumed by the load from the energy storage unit.

The device may include a master control and event management unit for controlling amount of electric energy replenished by the fuel cell unit and for controlling the electric energy supplied to the load. Further, the device may include a grid based battery charger coupled to the energy storage unit for recharging the energy storage unit from an external power source.

In another aspect, an apparatus for a electric/hybrid vehicle includes an energy storage unit operatively coupled to at least one electric motor of the electric/hybrid vehicle for delivering electric energy to the at least one electric motor, where the wherein the electric motor drives the electric/hybrid vehicle using the electric energy. The apparatus also includes a fuel cell unit coupled to the energy storage unit for replenishing electric energy consumed by the electric motor from the energy storage unit.

The apparatus may include a master control and event management unit for controlling amount of electric energy replenished by the fuel cell unit and for controlling the electric energy supplied to the load. Further, the apparatus may include a grid based battery charger coupled to the energy storage unit for recharging the energy storage unit from an external power source.

Other features of the embodiments will be apparent from the accompanying drawings and from the detailed description that follows.

### BRIEF DESCRIPTION OF THE VIEW OF THE DRAWING

FIG. 1 illustrates a block diagram of a fuel cell based hybrid electric renewable micro power pack, according to one embodiment.

The drawings described herein are for illustration purposes only and are not intended to limit the scope of the present disclosure in any way.

### DETAILED DESCRIPTION OF THE INVENTION

A fuel cell based hybrid electric renewable micro power pack is disclosed. The following description is merely exemplary in nature and is not intended to limit the present disclosure, applications, or uses. It should be understood that throughout the drawings, corresponding reference numerals indicate like or corresponding parts and features.

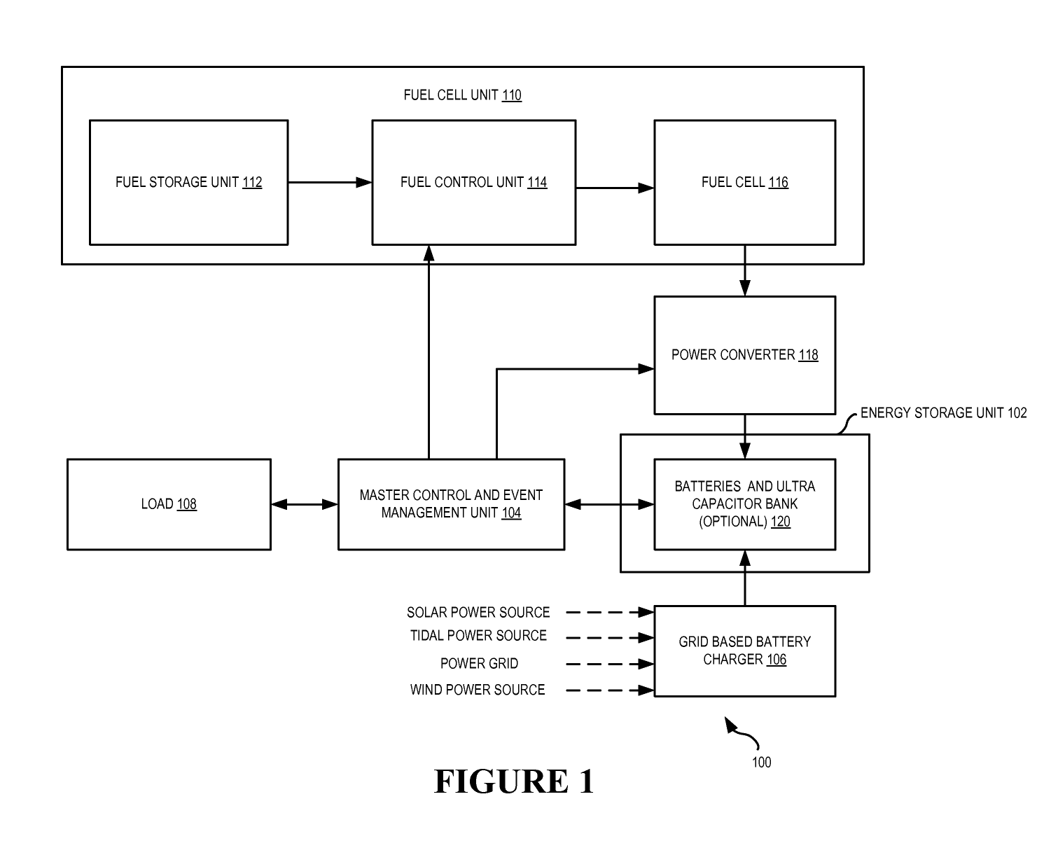

FIG. 1 illustrates a block diagram of a fuel cell based hybrid electric renewable micro power pack, according to one embodiment. In FIG. 1, the fuel cell based hybrid electric renewable micro power pack 100 includes an energy storage unit 102, a master control and event management unit 104, a grid based battery charger 106, a fuel cell unit 110 and a power converter 118. The energy storage unit 102 includes one or more single or hybrid chemistry batteries and an ultra-capacitor bank (optional) 120. The fuel cell unit 110 includes a fuel storage unit 112, a fuel control unit 114, and a fuel cell 116.

As can be seen from FIG. 1, the fuel cell based hybrid electric renewable micro power pack 100 is operatively coupled to a load 108. The load 108 may be associated with a battery operated device used in pure electric/hybrid vehicles, residential/industrial power generation system, hybrid power generation and storage station, wind/tidal/solar power generation and storage system, uninterrupted power supply system, stand alone power supply system and the like. In the power pack 100, the fuel cell 116 is coupled to the power converter 118 which in turn is connected to the batteries and ultra capacitor bank 120. Also, the grid based battery charger 106 is connected to the batteries 120. The output of the batteries 120 is connected to the master control and event management unit 104 which in turn is connected to the load 108.

The operation of the fuel based hybrid electric renewable micro power pack 100 is now described with respect to its implementation in an electric vehicle for driving electric motors 108 coupled to driving wheels of the electric vehicle. When the electric vehicle is parked near the electric power source, the batteries 120 can be charged using the grid based battery charger 106. However, when the electric vehicle is running, the stored electric energy from the batteries 120 is delivered to the electric motors 108 via the master control and event management unit 104 for driving the electric vehicle resulting in draining the charge in the batteries 120. It is understood that, more power is consumed when the electric vehicle moves forward from stand still or when the electric vehicle accelerates.

According to one embodiment of the present invention, the electric energy thus consumed by the electric motors 108 is replenished using the fuel cell unit 110. In operation, the fuel control unit 114 extracts the fuel stored in the fuel storage unit 112 and pumps appropriate amount of fuel into the fuel cell 116. The fuel storage unit 112 may include cartridges, high pressure tanks, or fuel absorbing particles/sponges. The fuel storage unit 112 stores compressed gas or hydride fuels such as pure/enriched hydrogen gas, metal hydride, methanol, natural gas propane and the like.

The fuel cell 116 converts fuel energy from the fuel into electric energy which is then provided to the power converter 118. The power converter 118 recharges the batteries 120 in such a way that the electric energy supplied by the power converter 118 is suitable to charge the batteries 120. It is appreciated that, the power converter 118 may employ linear and high frequency switch mode techniques to charge the batteries 120. Since, the batteries 120 and the ultra capacitor banks are charged using the fuel cell unit 110, the batteries 120 continue to deliver electric energy to the load 108 via the master control and event management unit 104 without being drained. It can be noted that, the fuel cell 116 generates the electric energy when the batteries 120 are not being charged from the electric power source via the grid based battery charger 106.

It can be noted that, the primary function of the master control and event management unit 104 is to actuate and control events and electric energy supplied to the electric motors 108 through its computation and control mechanism. The master control and event management unit 104 controls amount of electric energy generated by the fuel cell unit 110 based on the demand by the electric motors 108. This is achieved by generating a signal to the fuel control unit 114 to control volume, pressure and velocity of the fuel being pumped into the fuel cell 116. Accordingly, the fuel control unit 114 controls the volume, pressure and velocity of the fuel being pumped into the fuel cell 116 for replenishing electric energy.

In various embodiments, the power pack described in FIG. 1, provides an alternative to direct fuel cell driven loads. The power pack 100 provides a clean energy solution at economical and commercially viable cost. Also, the power pack 100 is smaller is size, rechargeable and hybrid in nature.

It will be recognized that the above described invention may be embodied in other specific forms without departing from the spirit or essential characteristics of the disclosure. Thus, it is understood that, the invention is not to be limited by the foregoing illustrative details, but it is rather to be defined by the appended claims.

What is claimed is:

1. A device comprising:
an energy storage unit operatively coupled to a load of a battery operated device for delivering electric energy to the load, wherein the battery operated device operates based on the electric energy supplied to the load; and
a fuel cell unit coupled to the energy storage unit for replenishing electric energy consumed by the load from the energy storage unit.

2. The device of claim 1 further comprises:
a power converter for providing appropriate amount of electric energy generated by the fuel cell unit to charge the energy storage unit.

3. The device of claim 1, further comprises:
a master control and event management unit for controlling amount of electric energy replenished by the fuel cell unit and for controlling the electric energy supplied to the load.

4. The device of claim 1, further comprises:
a grid based battery charger coupled to the energy storage unit for recharging the energy storage unit from an external power source.

5. The device of claim 1, wherein the fuel cell unit comprises:
a fuel storage unit for storing fuel for generation of electric energy;
a fuel control unit for regulating amount of fuel supplied for generation of electric energy based on requirement; and
a fuel cell for generating electric energy based on the amount of fuel supplied by the fuel control unit in order to replenish electric energy consumed by the load from the energy storage unit.

6. The device of claim 4, wherein the energy storage unit comprises:
one or more batteries and an ultra capacitor for storing electric energy generated by the fuel cell and from the external power source.

7. The device of claim 5, wherein the energy storage unit comprises:
one or more batteries and an ultra capacitor for storing electric energy generated by the fuel cell and from the external power source.

8. The device of claim 6, wherein the fuel control unit regulates amount of fuel supplied to the fuel cell based on a signal received from the master control and event management unit.

9. The device of claim 8, wherein the fuel cell generates the electric energy when the one or more batteries are not being charged from the electric power source via the grid based battery charger.

10. The device of claim 9, wherein the one or more batteries are selected from the group consisting of single chemistry battery and hybrid chemistry battery.

11. An apparatus for a electric/hybrid vehicle comprising:
an energy storage unit operatively coupled to at least one electric motor of the electric/hybrid vehicle for delivering electric energy to the at least one electric motor, wherein the electric motor drives the electric/hybrid vehicle using the electric energy; and
a fuel cell unit coupled to the energy storage unit for replenishing electric energy consumed by the electric motor from the energy storage unit.

12. The apparatus of claim 11 further comprises:
a power converter for providing appropriate amount of electric energy generated by the fuel cell unit to charge the energy storage unit.

13. The apparatus of claim 11, further comprises:
a master control and event management unit for controlling replenishment of electric energy by the fuel cell unit and for controlling the electric energy supplied to the at least one electric motor.

14. The apparatus of claim 11, further comprises:
a grid based battery charger coupled to the energy storage unit for recharging the energy storage unit from an external power source.

15. The apparatus of claim 11, wherein the fuel cell unit comprises:
a fuel storage unit for storing fuel for generation of electric energy;
a fuel control unit for regulating amount of fuel supplied for generation of electric energy based on requirement; and
a fuel cell for generating electric energy based on the amount of fuel supplied by the fuel control unit in order to replenish electric energy consumed by the at least one electric motor from the energy storage unit.

16. The apparatus of claim 14, wherein the energy storage unit comprises:
one or more batteries and an ultra capacitor for storing electric energy generated by the fuel cell and from the external power source.

17. The apparatus of claim 15, wherein the energy storage unit comprises:
one or more batteries and an ultra capacitor for storing electric energy generated by the fuel cell and from the external power source.

18. The apparatus of claim 16, wherein the fuel control unit regulates amount of fuel supplied to the fuel cell based on a signal from the master control and event management unit.

19. The apparatus of claim 18, wherein the fuel cell generates the electric energy when the one or more batteries are not being charged from the electric power source via the grid based battery charger.

20. The device of claim 19, wherein the one or more batteries are selected from the group consisting of single chemistry battery and hybrid chemistry battery.
